(19) United States
(12) Patent Application Publication
(10) Pub. No.: US 2018/0248453 A1
(43) Pub. Date: Aug. 30, 2018

(54) Rotor, Rotating Electric Machine Including Said Rotor, and Method of Manufacturing Said Rotor

(71) Applicant: Hitachi Automotive Systems, Ltd., Hitachinaka-shi, Ibaraki (JP)

(72) Inventors: Kenichi NAKAYAMA, Hitachinaka-shi (JP); Shinji YAMAZAKI, Hitachinaka-shi (JP); Tomohiro FUKUDA, Hitachinaka-shi (JP); Motoo KITAHARA, Hitachinaka-shi (JP)

(21) Appl. No.: 15/752,810

(22) PCT Filed: Jul. 28, 2016
(86) PCT No.: PCT/JP2016/072094

§ 371 Date: Feb. 14, 2018

(30) Foreign Application Priority Data
Sep. 2, 2015 (JP) 2015-172453

(51) Int. Cl. H02K 15/03; H02K 1/27; H02K 1/28; H02K 15/12

(52) U.S. Cl. CPC H02K 15/03; H02K 15/12; H02K 1/28; H02K 1/276

(57) ABSTRACT

A rotor with high productivity, a rotating electric machine including the rotor, and a method of manufacturing the rotor are provided. A rotor of a rotating electric machine includes a permanent magnet and a rotor core having a magnet insertion hole, the permanent magnet being inserted into the magnet insertion hole. The void between the permanent magnet and the magnet insertion hole is filled with a thermosetting powdered resin. A method of manufacturing the rotor of the rotating electric machine includes: a first step of inserting the permanent magnet and the thermosetting powdered resin into the magnet insertion hole; a second step of thermally hardening the powdered resin while rotating the rotor core; and a third step of magnetizing the permanent magnet.

### TECHNICAL FIELD

The present invention relates to a rotor, a rotating electric machine including the rotor, and a method of manufacturing the rotor.

### BACKGROUND ART

In a rotating electric machine, AC power is supplied to stator windings, to generate a rotating magnetic field. The rotor is rotated by this rotating magnetic field. Also, the mechanical energy applied to the rotor can be converted into electric energy, and AC power can be output from coils. In view of this, a permanent-magnet rotating electric machine to be used for driving an electrically-driven vehicle such as a hybrid vehicle (or an electric vehicle (EV) is expected to have a higher rotating speed. Particularly, there is a demand for a permanent-magnet rotating electric machine that is capable of high power output even in a high-speed rotation range. Therefore, a rotating electric machine with buried permanent magnets having auxiliary salient poles is often used as a conventional permanent-magnet rotating electric machine. Such a rotating electric machine with buried permanent magnets is capable of field weakening at a time of high-speed rotation and can use reluctance torque. For example, PTL 1 discloses the structure of a permanent-magnet rotating electric machine that is capable of both high power output and mechanical high-speed rotation (see PTL 1, for example).

In the rotor of such a permanent-magnet rotating electric machine that can cope with high-speed rotation, magnet insertion holes each having a substantially rectangular cross-section are provided for respective magnetic poles. Long permanent magnets having a rectangular cross-section are inserted into the magnet insertion holes. Permanent magnets are inserted into the magnet insertion holes. When the rotating electric machine is driven, and the rotor is rotated, a high stress is applied, as a result of centrifugal force, particularly to the corner portion of each magnet insertion hole with which a corner portion of the corresponding permanent magnet is in contact. In a case where the stress is high, the magnets might be broken, or the rotor might be broken. In a rotating electric machine, AC power is supplied to coils, to generate a rotating magnetic field. The rotor is rotated by this rotating magnetic field. Also, in a rotating electric machine, the mechanical energy applied to the rotor is converted into electric energy, and AC power is output from the coils. That is, a rotating electric machine functions as an electric motor or a generator.

### CITATION LIST

### Patent Literature

PTL 1: JP 2006-187189 A

### SUMMARY OF INVENTION

### Technical Problem

In the rotor of the permanent-magnet rotating electric machine disclosed in PTL 1, a liquid filling material such as varnish enters between rotor cores, and therefore, a removal operation or the like is required in a post-process.

### Solution to Problem

To solve the above problem, a structure disclosed in the claims is adopted, for example.

The present application discloses more than one means to solve the above problem. An example of the means is a rotor of a rotating electric machine. The rotor includes a permanent magnet and a rotor core having a magnet insertion hole into which the permanent magnet is inserted, the void between the permanent magnet and the magnet insertion hole being filled with a thermosetting powdered resin.

### Advantageous Effects of Invention

According to the present invention, it is possible to provide a rotor with high productivity, a rotating electric machine including the rotor, and a method of manufacturing the rotor.

The objects, structures, and effects other than the above will become apparent from the embodiments described below.

### BRIEF DESCRIPTION OF DRAWINGS

FIG. 1 is a schematic diagram showing the entire structure of a rotating electric machine.

FIG. 2 is a perspective view of a stator of the rotating electric machine.

FIG. 3 is a perspective view of a stator core 132.

FIG. 4 is a diagram showing an electromagnetic steel sheet 133.

FIG. 5 is a perspective view of stator coils 138.

FIG. 6 is a diagram showing star connections.

FIG. 7 is a diagram for explaining segment coils of stator coils: (a) is a diagram showing a segment coil; (b) is a diagram for explaining coil formation with segment coils; and (c) is a diagram for explaining arrangement of segment coils in slots.

FIG. 8 is a perspective view of a stator coil 138U.

FIG. 9 is a perspective view of a stator coil 138U1.

FIG. 10 is a perspective view of a stator coil 138U2.

FIG. 11 is a diagram showing cross-sections of the rotor 11 and the stator 20.

FIG. 12 is a flowchart showing a manufacturing process.

FIG. 13 is a diagram for explaining a process of inserting powdered resin and a process of inserting a magnet.

FIG. 14 is a diagram for explaining a process of inserting powdered resin blocks and a process of inserting a magnet.

FIG. 15 is a diagram for explaining a process of inserting a magnet coated with powdered resin into a magnet insertion hole.

FIG. 16 is a diagram for explaining a process of inserting a magnet into a magnet insertion hole coated with powdered resin.

FIG. 17 is a block diagram showing the configuration of a vehicle in which rotating electric machines according to the present invention are mounted.

### DESCRIPTION OF EMBODIMENTS

The following is a description of an embodiment of the present invention, with reference to the drawings.

A rotating electric machine according to this embodiment is a rotating electric machine suitable for use in automobile driving. Here, a so-called electric vehicle that uses a rotating electric machine may be a hybrid electric vehicle (HEV) that includes both an engine and a rotating electric machine, or a truly electric vehicle (EV) that runs only with a rotating electric machine and does not use an engine. The rotating electric machine described below can be used for both types, and therefore, the rotating electric machine described below is used in a hybrid automobile as a typical example.

Also, in the description below, the “axial direction” means the direction along the rotating shaft of the rotating electric machine. The circumferential direction is the direction along the direction of rotation of the rotating electric machine. The “radial direction” is the direction of the moving radius (radial direction), with the center being the rotating shaft of the rotating electric machine. The “inner circumferential side” is the inner side in the radial direction (the inner radial side), and the “outer circumferential side” is the opposite side or the outer side in the radial direction. (the outer radial side).

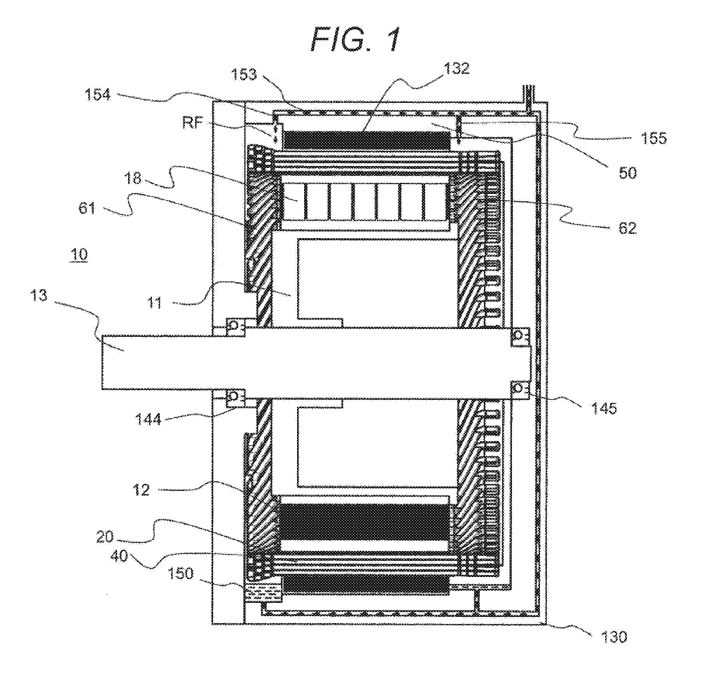

FIG. 1 is a cross-sectional view of a rotating electric machine including a stator according to the present invention. The rotating electric machine 10 includes a housing 50, stator 20, a stator core 132, stator coils 60, and a rotor 11.

The stator 20 is secured to the inner circumferential side of the housing 50. The rotor 11 is rotatably supported by the inner circumferential side of the stator 20. The housing 50 is shaped into a cylindrical form by cutting of a ferrous metal such as carbon steel, casting of cast steel or aluminum alloy, stamping. The housing 50 forms the outer coating of the rotating electric machine. The housing 50 is called a casing or a frame.

The housing 50 is shaped into a cylindrical form by drawing of a steel sheet (such as a high-strength steel sheet) of about 2 to 5 mm in thickness. Flanges to be attached to a liquid-cooled jacket 130 are provided on the housing 50. The flanges protrude from the rim of an end face of the cylindrical housing 50 toward the outside in the radial direction. The flanges are formed by cutting of portions other than the flanges at the end portions formed at the time of drawing, and are integrally formed with the housing 50. Alternatively, the housing 112 may not be provided, and the stator 20 may be secured directly to the case.

The liquid-cooled jacket 130 is secured to the outer circumferential side of the housing 50. The inner circumferential wall of the liquid-cooled jacket 130 and the outer circumferential wall of the housing 50 constitute a refrigerant path 153 for a liquid refrigerant RF such as oil, and this refrigerant path 154 is designed not to cause any liquid leakage. The liquid-cooled jacket 130 houses bearings 144 and 145, and is also called a bearing bracket.

In the case of direct liquid cooling, the liquid as the refrigerant RF stored in a refrigerant (oil) storage space 150 passes through the refrigerant path 153, flows toward the stator 20 from refrigerant paths 154 and 155, and then cools the stator 20.

The stator 20 includes the stator core 132 and the stator coils 60. The stator core 132 is formed with stacked thin silicon steel sheets. The stator coils 60 are wound around a large number of slots 420 formed at the inner circumferential portion of the stator core 132. The heat generated from the stator coils 60 is transmitted to the liquid-cooled jacket 130 via the stator core 132, and is released by the refrigerant RF flowing in the liquid-cooled jacket 130.

The rotor 11 includes a rotor core 12 and a shaft 13. The rotor core 12 is formed with stacked thin silicon steel sheets. The shaft 13 is secured at the center of the rotor core 12. The shaft 13 is rotatably supported by the bearings 144 and 145 attached to the liquid-cooled jacket 130, and rotates in a predetermined position in the stator 20, the shaft 13 in the position facing the stator 20. A permanent magnet 18 and an end ring 19 are also provided in the rotor 11.

The rotating electric machine 10 is provided inside the liquid-cooled jacket 130 as shown in FIG. 1, and includes the housing 50, the stator 20 including the stator core 132 secured to the housing 50, and the rotor 11 rotatably provided in the stator. The liquid-cooled jacket 130 is formed with an engine case or a transmission case.

This rotating electric machine 10 is a permanent-magnet-containing three-phase synchronous motor. As a three-phase alternating current is supplied to the stator coils 60 wound around the stator core 132, the rotating electric machine 10 functions as an electric motor that rotates the rotor 11. When being driven by an engine, the rotating electric machine 10 also functions as a generator, and generates three-phase AC power. That is, the rotating electric machine 10 has both the functions of an electric motor that generates rotating torque in accordance with electric energy, and the functions of a generator that generates power in accordance with mechanical energy. The functions can be selectively used in accordance with a running condition of the automobile.

The stator 20 includes the cylindrical stator core 132 and the stator coils 60 mounted on the stator core 132.

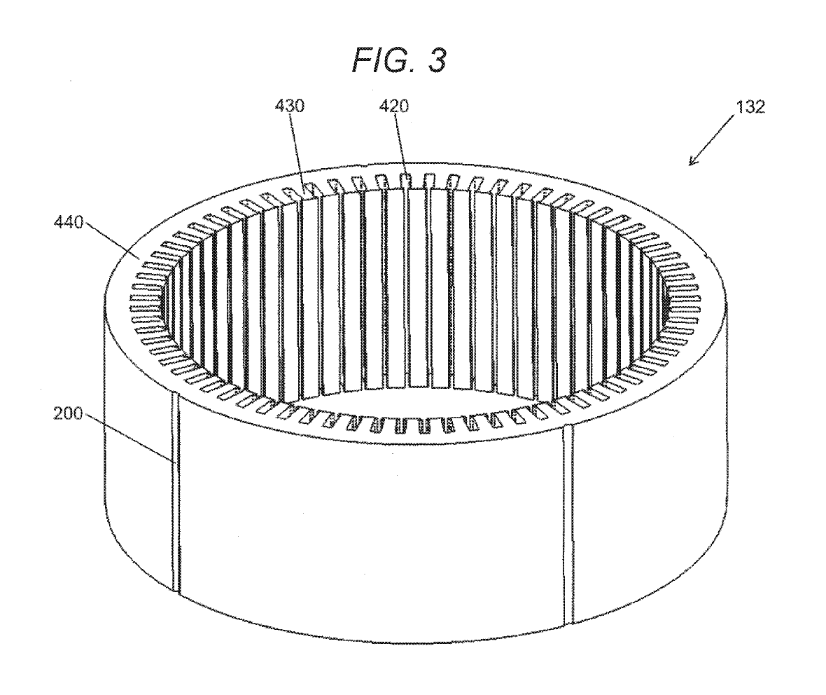

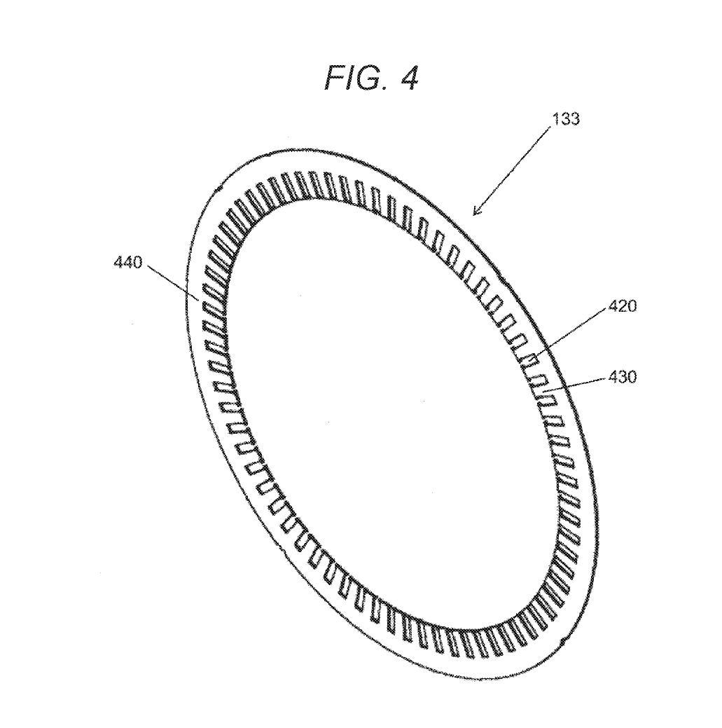

Referring now to FIGS. 3 and 4, the stator core 132 is described. FIG. 3 is a perspective view of the stator core 132. FIG. 4 is a perspective view of an electromagnetic steel sheet 133 forming the stator core 132. As shown in FIG. 3, the stator core 132 is designed so that the slots 420 parallel to the axial direction of the stator core 132 are arranged at regular intervals in the circumferential direction.

The number of the slots 420 is 72 in this embodiment, for example, and the above described stator coils 60 are accommodated by the slots 420. An opening is formed on the inner circumferential side of each slot 420, and the width of the opening in the circumferential direction is substantially the same or slightly smaller than the coil mounting portion of each slot 420 on which the stator coils 60 are mounted.

Teeth 430 are formed between the slots 420, and each of the teeth 430 is integrally formed with a ring-like core back 440. That is, the stator core 132 is an integrated core formed by integrally molding the teeth 430 and the core back 440.

The teeth 430 guide a rotating magnetic field generated by the stator coils 60 to the rotor 11, and function to cause the rotor 11 to generate rotating torque.

The stator core 132 is formed by molding electromagnetic steel sheets 133 of about 0.05 to 1.0 mm in thickness (see FIG. 4) through stamping, and stacking the molded ring-like electromagnetic steel sheets 133. Welded portions 200 are formed in the outer circumferential portion of the cylindrical stator core 132 by TIG welding or laser welding, and the welded portions 200 are parallel to the axial direction of the stator core 132. As shown in FIG. 4, the welded portions 200 are formed in semicircular weld grooves 20 formed beforehand in the outer circumferential portion of the stator core 132. It should be noted that the stacked electromagnetic steel sheets 133 maybe secured only by swaging.

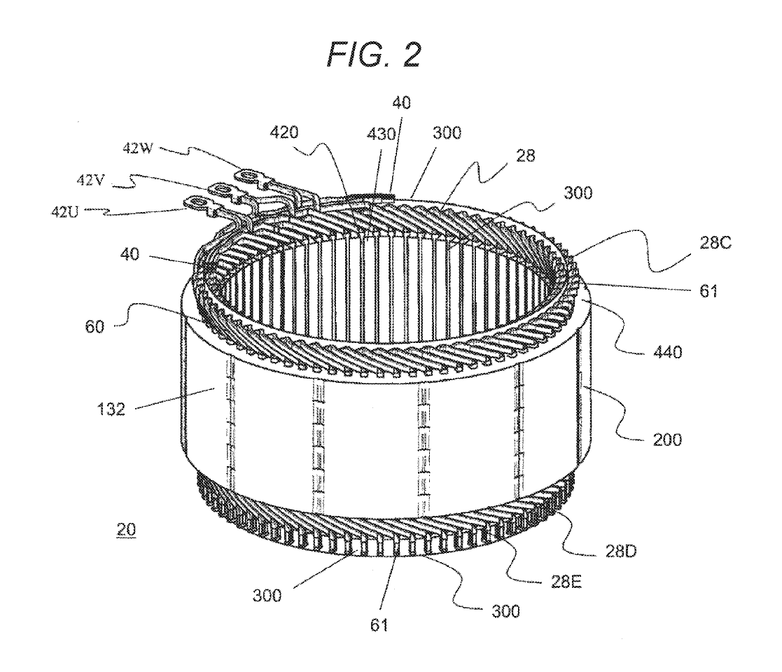

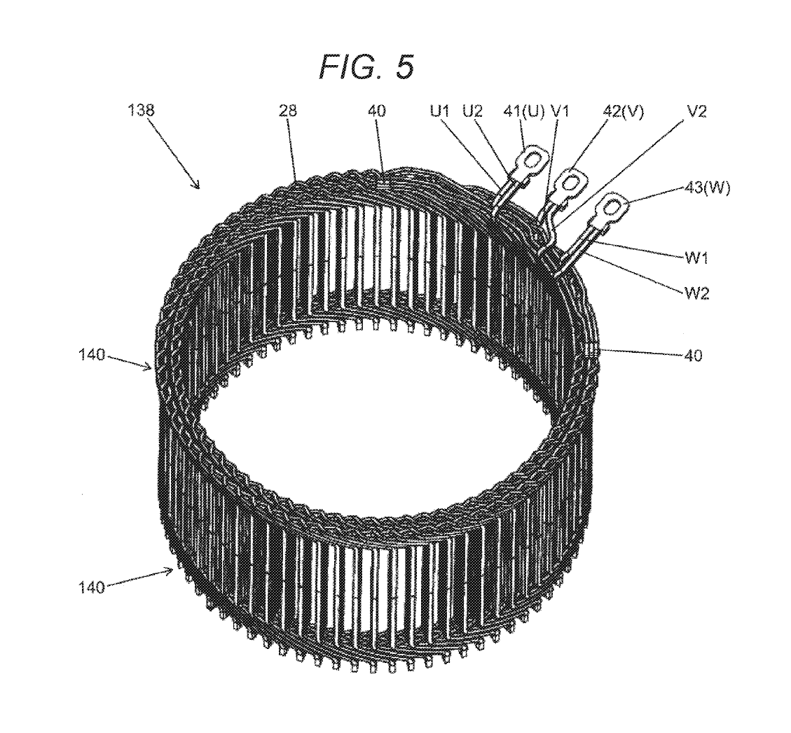

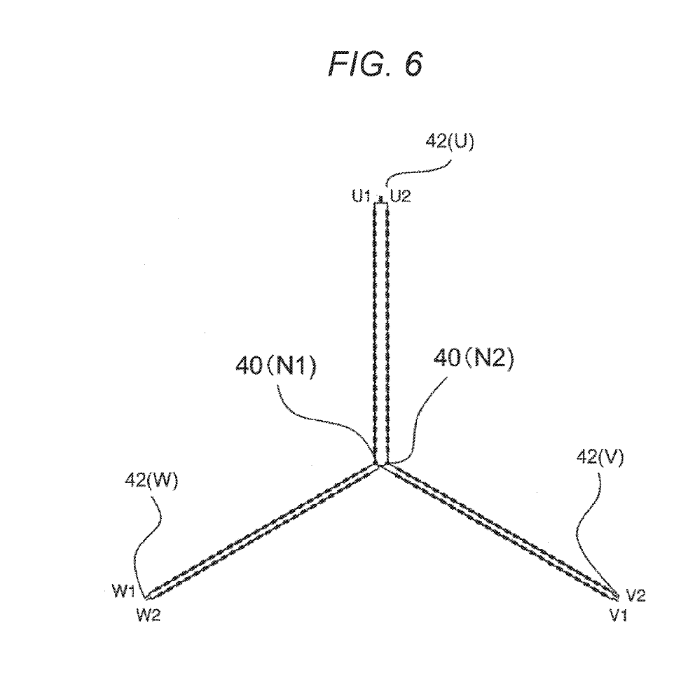

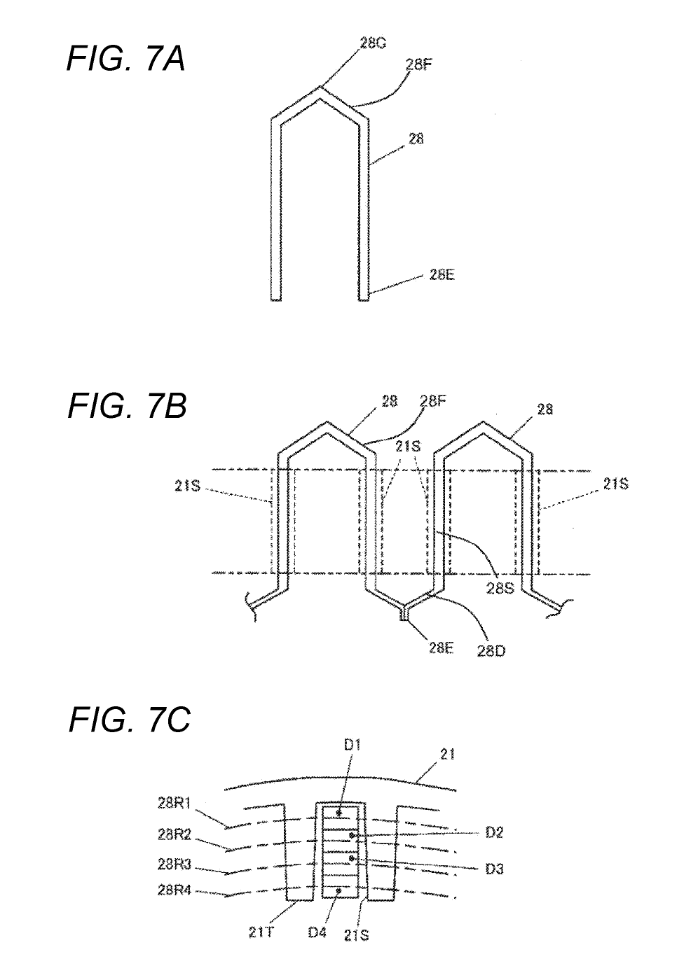

Referring now to FIG. 2 and FIGS. 5 through 8, the stator coils 60 are described. FIG. 5 is a perspective view of stator coils 60 of three phases. FIG. 7 is a diagram showing star connections.

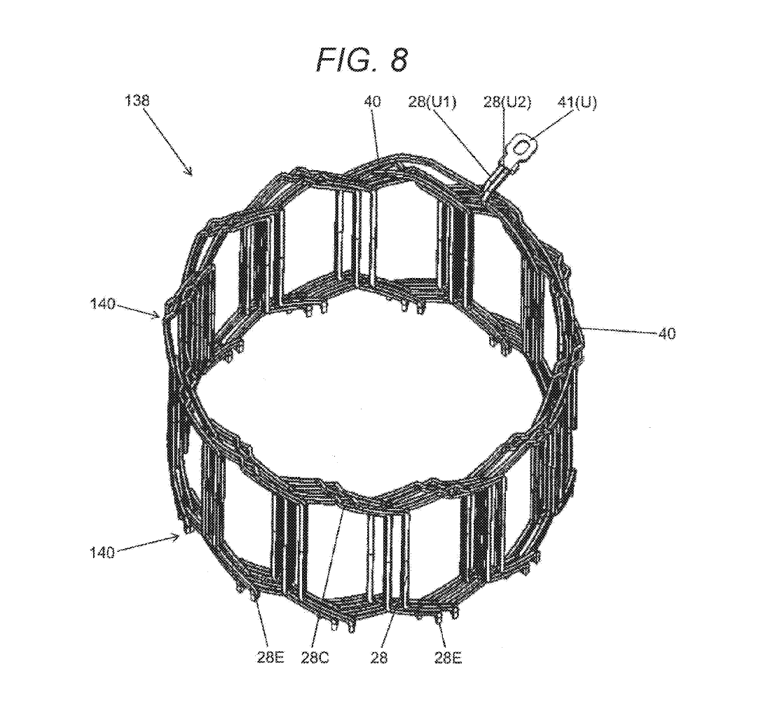

FIGS. 8, 9, and 10 are perspective views of the stator coil 60 of a U-phase, the stator roil 60 of a U1-phase, and the stator coil 60 of a U2-phase that are wound around the stator core 132.

Stator coils 138 are connected by a star connection structure shown in FIG. 7. In this embodiment, stator coils 138 with a two-star structure in which two star connections are connected in parallel are adopted. Specifically, the structure includes star connections of a U1-phase, a V1-phase, and a W1-phase, and star connections of a U2-phase, a V2-phase, and a W2-phase. The lead wires of the U1- and U2-phases are combined into one by an AC terminal 41U, the lead wires of the V1- and V2-phases are combined into one by an AC terminal 41V, and the lead wires of the W1- and W2-phases are combined into one by an AC terminal 41W. N1 and N2 represent the neutral points of the respective star connections.

The stator coils 60 are wound by a distributed winding method, and are connected by a star connection structure. Distributed winding is a winding method by which a phase winding is wound around the stator core 132 so that the phase winding is housed in two slots 420 between which more than one slot 420 exists. In this embodiment, distributed winding is adopted as the winding method. Therefore, the magnetic flux distribution to be formed is closer to sinusoidal waves than that with concentrated winding, and reluctance torque is easily generated. Accordingly, in this rotating electric machine 10, the controllability of control using field-weakening control and reluctance torque becomes higher. Thus, the rotating electric machine 10 can be used in a wide rotating speed range from a low rotating speed to a high rotating speed, and excellent motor characteristics suitable for electric vehicles can be achieved.

The stator coils 60 form star-connected phase coils of three phases, and may have a circular or rectangular cross-section. However, the cross-section in each slot 420 should be used as effectively as possible, and the spaces in the slots should be minimized, to achieve higher efficiency. Therefore, a rectangular cross-section is preferable in achieving higher efficiency. It should be noted that the rectangular cross-section of each stator coil 60 may be short in the circumferential direction and be long in the radial direction of the stator core 132. Alternatively, the rectangular cross-section may be long in the circumferential direction and be short in the radial direction of the stator core 132.

In this embodiment, rectangular wires are used as the stator coils 60 so that a rectangular cross-section of the stator coil 60 in each slot 420 is long in the circumferential direction of the stator core 132 and is short in the radial direction of the stator core 132. The outer circumferences of the rectangular wires are coated with an insulating coating.

An oxygen-free copper or an oxygen-containing copper is used as the stator coils 138. In the case of an oxygen-containing copper, the oxygen content is about 10 to 1000 ppm.

As shown in FIG. 7(a), a segment coil 28 having a U-shape is molded so that a bent point is located at a vertex 28C of a non-welding-side coil end 61. Here, the vertex 28C of the non-welding-side coil end 61 should have such a shape that the direction of the conductor is reversed in the U-shape.

Specifically, when viewed from the radial direction, the vertex 28C of the non-welding-side coil end 61 and diagonal conductor portions 28F of the non-welding-side coil end 61 do not necessarily form a triangular shape as in FIG. 7. For example, at part of the vertex 28C of the non-welding-side coil end 61, such a shape may be formed that the conductor may be substantially parallel to the end face of the stator core 132 (such a shape that the vertex 28C of the non-welding-side coil end 61 and the diagonal conductor portions 28F of the non-welding-side coil end 61 form substantially a trapezoidal shape when viewed from the radial direction.).

The segment coil 28 is inserted into stator slots 420 from the axial direction. At a conductor end portion 28E, the segment coil 28 is then connected (by welding or the like) to another segment coil 28 inserted at a distance equivalent to a predetermined number of slots 420 as shown in FIG. 7(b).

In this stage, straight conductor portions 28S that are the portions inserted into slots 420, and diagonal conductor portions 28D that are portions diagonally extending to the conductor end portions 28E of the segment coils 28 to which the segment coil 28 is connected are formed (the diagonal conductor portions 28D and the end portions 28E are formed by bending) in the segment coil 28.

Two, four, six, . . . (a multiple of 2) of segment coils 28 are inserted into a slot 420. FIG. 2 shows an example where four segment coils 28 are inserted into one slot 420. Since the conductor has a substantially rectangular cross-section, the occupied area in each slot 420 can be increased, and the efficiency of the rotating electric machine 10 becomes higher.

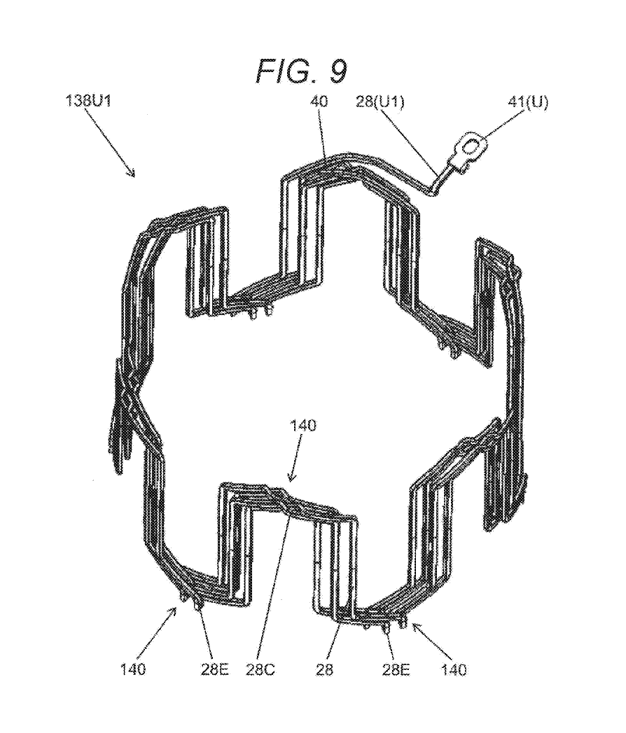

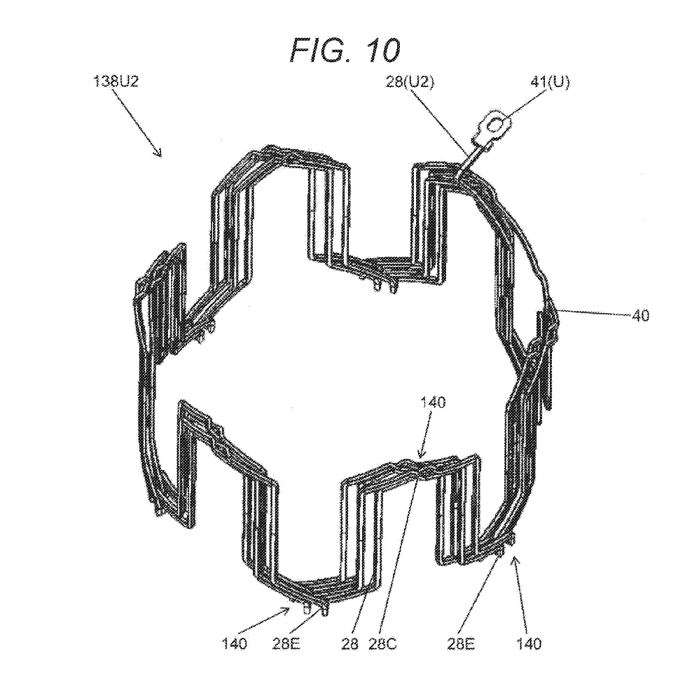

FIG. 8 is a diagram showing a case where the connecting process shown in FIG. 7(b) is repeated until the segment coils 28 form a ring, and a coil of one phase (a U-phase, for example) is formed. The coil of one phase is designed so that the conductor end portions 28E are located on one side in the axial direction, and a welding-side coil end 62 at which the conductor end portions 28E are located, and the non-welding-side coil end 61 are formed. In the coil of one phase, the terminal of each phase (a terminal 42U of the U-phase in the examples in FIGS. 9 and 10) are formed at one end, and a neutral wire 41 is formed at the other end. The diagram shows a connecting portion 800 of a segment coil. In this embodiment, there are 144 connecting portions 800. The connecting portions are arranged at an appropriate distance from one another. The connecting method is TIG welding of arc welding, plasma welding, or the like. The connection is performed by melting the base material of copper wires. Argon, helium, a mixture of argon and helium, or the like is used as the shield gas.

As shown in FIG. 5, the stator coils 60 are formed with a total of six sets (U1, U2, V1, V2, W1, and W2) of coils adhering tightly to the stator core 132. The six sets of coils constituting the stator coils 60 are arranged at an appropriate distance from one another with the slots 420.

AC terminals 41(U), 42(V), and 43(W) that are input/output coil conductors of the respective stator coils 60 of the U-, V-, and W phases, and neutral-point connecting conductors 40 are drawn to one coil end 140 of the stator coils 60.

It should be noted that, to improve the working efficiency in assembling the rotating electric machine 10, the AC terminals 41(U), 42(V), and 43(W) for receiving three-phase AC power are arranged to protrude from the coil end 140 to the outside in the axial direction of the stator core 132. The stator 20 is then connected to a power inverter (not shown) via the AC terminals 41(U), 42(V), and 43(W) so that AC power is supplied.

As shown in FIG. 2, of the stator coils 60, the coil ends 140 that protrude from the stator core 132 to the outside in the axial direction have crossover wires arranged thereon, so that the coil ends 140 are neatly arranged, leading to a reduction in the size of the entire rotating electric machine 10. As the coil ends 140 are neatly arranged, reliability in insulating characteristics can also be increased.

The stator coils 60 are designed so that the outer circumferences of the conductors are coated with an insulating coating, and thus, electric insulation is maintained. However, insulating paper 300 (see FIG. 2) is preferably provided in addition to the insulating coating, so that the withstand voltage is maintained, and even higher reliability can be achieved.

The insulating paper 300 is provided in the slots 420 and at the coil ends 140. The insulating paper 300 (so-called slot liners 310) provided in the slots 420 are provided between the segment coils 28 inserted in the slots 420 and between the segment coils 28 and the inner faces of the slots 420, to increase the withstand voltage between the segment coils and between the segment coils 28 and the inner faces of the slots 420.

The insulating paper 300 provided at the coil ends 140 are provided in a ring-like form between the segment coils, to insulate the coil ends 140 from each other and insulate the conductors from one another. The insulating paper 300 also serves as a holding member that prevents dripping of a resin member (such as polyester or liquid epoxy varnish) dropped on the entire or part of the stator coils.

As described above, in the rotating electric machine 10 according to this embodiment, the insulating paper 300 is provided in the slots 420 and at the coil ends 140. Thus, the necessary withstand voltage can be maintained, even if the insulating coating is damaged or deteriorates. It should be noted that the insulating paper 300 is an insulating sheet made of heat-resistant polyamide paper, and is about 0.1 to 0.5 mm in thickness.

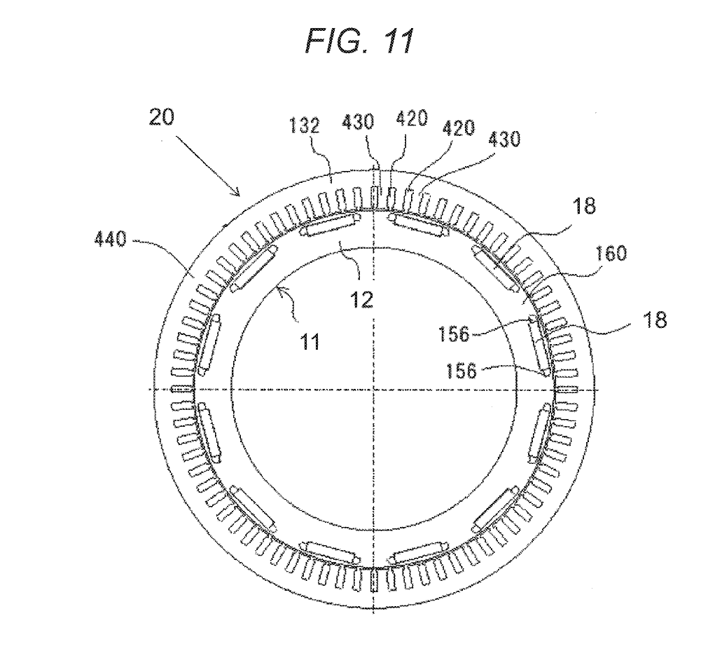

FIG. 11 is a diagram showing cross-sections of the stator 20 and the rotor 11. In the rotor core 12, magnet insertion holes 810 into which rectangular or sector magnets are to be inserted are formed at regular intervals, and a permanent magnet 18 is buried in each of the magnet insertion holes 810.

The width of each magnet insertion hole 810 in the circumferential direction is greater than the width of each permanent magnet 18 in the circumferential direction, and magnetic voids 156 are formed on both sides of each permanent magnet 18.

The permanent magnets 18 function to form field poles of the rotor 11. In this embodiment, one permanent magnet forms one magnetic pole. However, each magnetic pole may be formed with more than one magnet. As the number of permanent magnets 18 is increased, the magnetic flux density of each magnetic pole generated by permanent magnets becomes higher, and magnetic torque can be increased.

The magnetization direction of the permanent magnets 18 is parallel to the radial direction, and the magnetization direction is reversed for each field pole. Specifically, where the stator-side face of a permanent magnet 18 for forming a certain magnetic pole is magnetized as the N-pole while the axis-side face thereof is magnetized as the S-pole, the stator-side face of a permanent magnet 18 forming an adjacent magnet pole is magnetized as the S-pole, and the axis-side face thereof is magnetized as the N-pole. These permanent magnets 18 are magnetized so that the magnetization direction is switched for each magnetic pole, and are arranged in the circumferential direction. In this embodiment, 12 permanent magnets 18 are arranged at regular intervals, and the rotor 11 forms 12 magnetic poles.

Here, neodymium- or samarium-based sintered magnets, ferrite magnets, neodymium-based bond magnets, or the like can be used as the permanent magnets 18.

In this embodiment, auxiliary magnetic poles 160 are formed between the permanent magnets 18 each forming a magnetic pole. The auxiliary magnetic poles 160 serve to lower the magnetic resistance of the q-axis magnetic flux generated by the stator coils 138. With the auxiliary magnetic poles 160, the magnetic resistance of the q-axis magnetic flux becomes much lower than the magnetic resistance of the d-axis magnetic flux. As a result, large reluctance torque is generated.

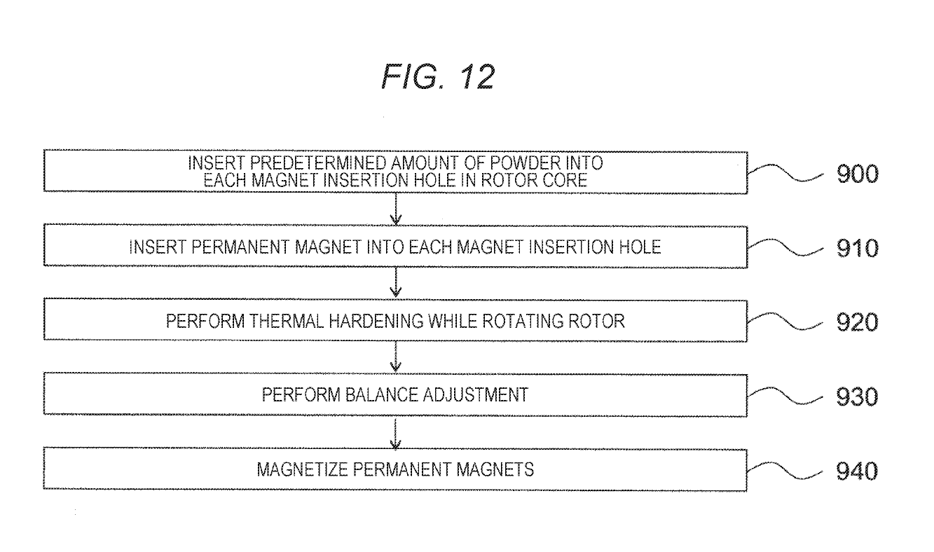

FIG. 12 is a flowchart showing a manufacturing process according to an embodiment of the present invention.

In a step 900, a smaller amount of powdered resin 800 than the void between each magnet insertion hole 810 and a permanent magnet 18 inserted.

An epoxy-based thermosetting resin is mainly used as the powdered resin 800. The powder particle size is 70 to 500 μm. The particle size of the powdered resin 800 is relatively large so that the powdered resin 800 is easily inserted into each magnet insertion hole 810. The glass-transition temperature of the powdered resin 800 depends on the usage environment, and is about 110 to 160 degrees.

In a step 910, the permanent magnets 18 are inserted into the respective magnet insertion holes 810.

In a step 920, after the permanent magnets 18 are inserted into the respective magnet insertion holes 810, the powdered resin 800 is thermally hardened while the rotor 11 is rotated. Being thermally hardened while being rotated, the respective magnet insertion holes 810 are evenly filled with the powdered resin 800. Thus, imbalance between the permanent magnets 18 can be minimized.

In a step 930, after the powdered resin 800 is hardened, balance adjustment is performed.

In a step 940, the permanent magnets 18 are magnetized.

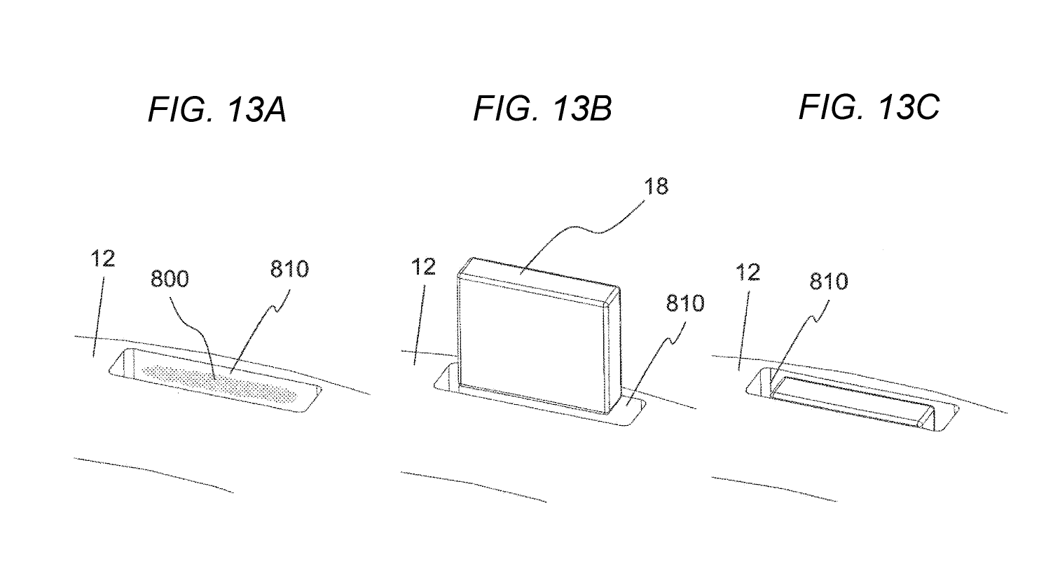

FIG. 13 shows the process of inserting the powdered resin 800.

As shown in FIG. 13(a), a smaller amount of powdered resin 800 than the void between each magnet insertion hole 810 and a permanent magnet 18 is inserted. The powdered resin 800 may be inserted in the form of power, but may be formed into blocks beforehand so as to increase working efficiency.

As shown in FIG. 13(b), the permanent magnets 18 are inserted into the respective magnet insertion holes 810.

FIG. 13(c) is a perspective view of a permanent magnet 18 inserted in a magnet insertion hole 810. The powdered resin 800 may be inserted after the permanent magnets 18 are inserted.

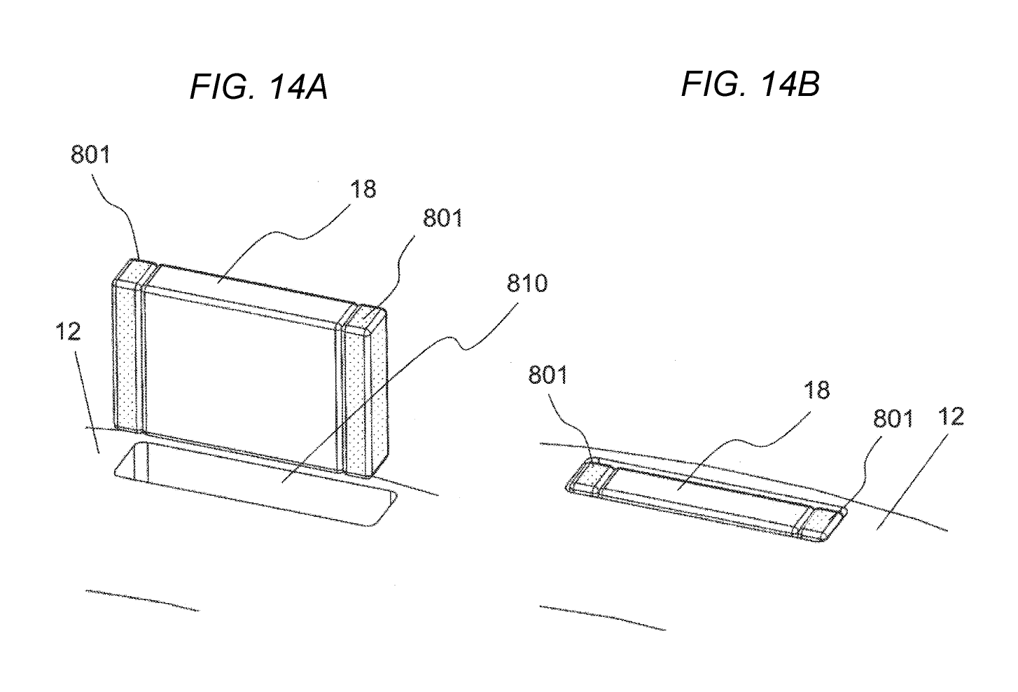

FIG. 14 shows the insertion process in a case where powdered resin blocks 801 are used.

FIG. 14(a) is a perspective view of a permanent magnet 18 and powdered resin blocks 801 to be inserted simultaneously into a magnet insertion hole 810. FIG. 14(b) is a perspective view of powdered resin blocks 801 inserted after insertion of a permanent magnet 18. When to insert powdered resin blocks 801 can be determined in accordance with the shape of each magnet insertion hole 810 or the size of the gap between a permanent magnet 18 and a magnet insertion hole 810.

In a case where powdered resin blocks 801 are used, scattering of the powdered resin can be prevented, and thus, working efficiency is increased. To increase the viscosity of the adhesive, the adhesive may be mixed with the powdered resin 800.

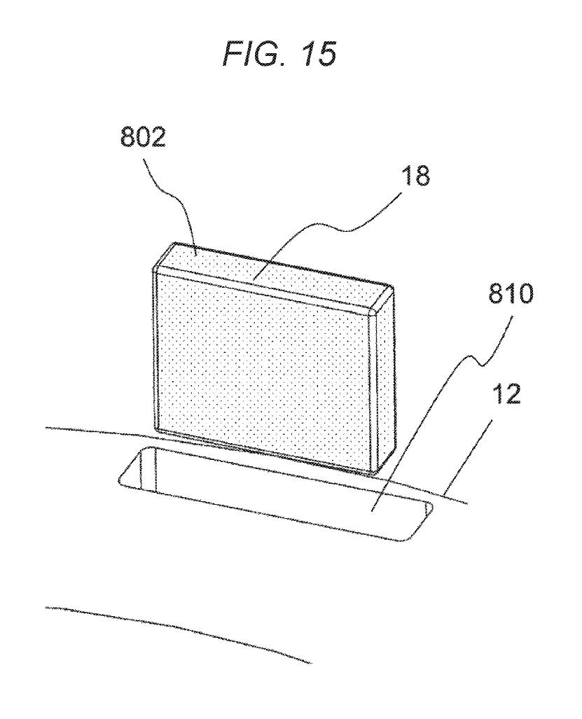

FIG. 15 is a perspective view of a permanent magnet 18 to which powdered resin 802 is attached in advance. In this case, the powdered resin 802 is attached to the surfaces of the permanent magnets 18 by electrostatic coating or the like. Accordingly, permanent magnets not subjected to any surface treatment may be used as the permanent magnets 18. The permanent magnets 18 are normally subjected to a surface treatment against rust and corrosion. However, as the permanent magnets 18 are coated with the powdered resin 802, the surface treatment process can be skipped.

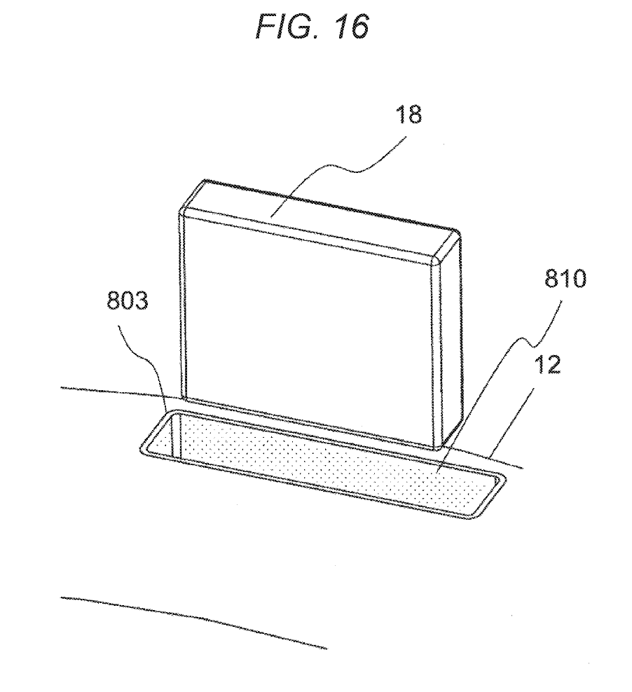

FIG. 16 is a perspective view of a permanent magnet 18 to be inserted after the powdered resin 802 is attached to each magnet insertion hole 810. The powdered resin 802 is attached to the surface of each magnet insertion hole 810 by electrostatic coating or the like, and the permanent magnets 18 are then inserted.

By any of the methods described above with reference to FIGS. 13 through 16, each magnet insertion hole 810 is not completely filled with the powdered resin 800, 801, or 802, as long as the magnets can be secured suitably in the usage environment. The powdered resin 800, 801, and 802 may be colored to indicate that the resin is a powdered resin.

By these methods, leakage of the adhesive and the like from the electromagnetic steel sheets 133 can be reduced. Also, where a liquid adhesive or the like is used, a gelation process is required. However, such a gelation process becomes unnecessary. As a result, productivity can be increased. Further, the powdered resin 800, 801, and 802 is applied onto the electromagnetic steel sheets 133 in the end. Thus, eddy current can be reduced, and motor efficiency can be increased.

A permanent-magnet rotating electric machine has been described so far. Since a feature of the present invention relates to a rotor, the stator is of a wave winding type. However, the stator may be of a multiple winding type or a concentrated winding type. An inward rotation type is next described, but an outward rotation type can also be used.

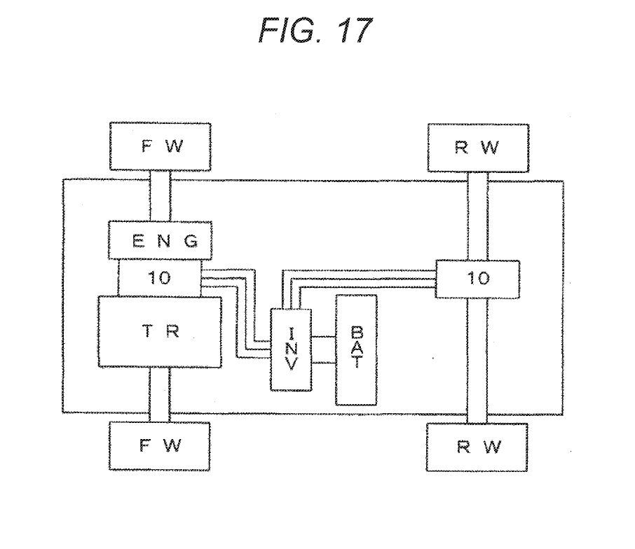

Referring now to FIG. 17, the configuration of a vehicle in which rotating electric machines 10 according to this embodiment are mounted is described. FIG. 17 shows the power train of a four-wheel-drive hybrid vehicle. The principal power supplies on the front side are an engine ENG and a rotating electric machine 10. The power generated by the engine ENG and the rotating electric machine 10 is subjected to gearshifting by a transmission TR, and thus, power is transmitted to the front-side drive wheels FW. Meanwhile, when the rear wheels are driven, a rotating electric machine 10 provided on the rear side is mechanically connected to rear-side drive wheels RW, and thus, power is transmitted.

The rotating electric machines 10 activate the engine, and, in accordance with a running condition of the vehicle, switch between generation of a driving force and generation of power collected as electric energy from the energy when the vehicle slows down. Driving and power generating operations of the rotating electric machines 10 are controlled by a power inverter INV so that the torque and the number of revolutions are optimized in accordance with a driving situation of the vehicle. The power necessary for driving the rotating electric machines 10 is supplied from a battery BAT via the power inverter INV. When the rotating electric machines 10 are in power generating operations, the battery BAT is charged with electric energy via the power inverter INV.

Here, the rotating electric machine 10 as the power source on the front side is provided between the engine ENG and the transmission TR, and has the above described structure. As for the rotating electric machine 10 as the drive power source on the rear side, the same rotating electric machine as that on the front side may be used, or some other rotating electric machine having a conventional structure may be used. This is also applied to hybrid vehicle that is not of a four-wheel-drive type.

As described above, the present invention can provide a rotor for a rotating electric machine that has small eddy current and excellent motor efficiency.

It should be noted that the present invention is not limited to the above described embodiment, and includes various modifications. For example, the above described embodiment has been described in detail for ease of understanding of the present invention, and the present invention is not limited to a structure that includes all the components described above. Also, it is possible to add a component to the embodiment, delete one of the components of the embodiment, or replace one of the components of the embodiment with some other component.

Although rotating electric machines for electric vehicles and hybrid electric vehicles have been described as an example of application of the present invention, the present invention can also be applied to industrial motors for elevators and the like and motors for household appliances such as air-conditioner compressors, as well as auxiliary motors for automobiles, such as alternators, starter generators (including motor generators), electric compressors, and electric pumps.

### REFERENCE SIGNS LIST

10 Rotating electric machine
11 Rotor
12 Rotor core
13 Shaft
18 Permanent magnet
20 Stator
28 Segment coil
28C Vertex
28E End portion
28F Diagonal conductor portion
40 Neutral-point connecting conductor
42U AC terminal
42V AC terminal
42W AC terminal
50 Housing
60 Stator coil
61 Non-welding-side coil end
62 Welding-side coil end
130 Liquid-cooled jacket
132 Stator core
133 Electromagnetic steel sheet
138 Stator coil
140 Coil end
144, 145 Bearing
150 Storage space
154, 155 Refrigerant path
156 Magnetic void
160 Auxiliary magnetic pole
200 Welded portion
210 Weld groove
300 Insulating paper
310 Slot liner
420 Slot
430 Teeth
440 Core back
800 Powdered resin
801 Powdered resin block
802 Powdered resin
810 Magnet insertion hole
900 Manufacturing process

1. A rotor of a rotating electric machine, the rotor comprising:
a permanent magnet; and
a rotor core having a magnet insertion hole, the permanent magnet being inserted into the magnet insertion hole,
wherein a void between the permanent magnet and the magnet insertion hole is filled with a thermosetting powdered resin.

2. The rotor of the rotating electric machine according to claim 1, wherein the powdered resin is an epoxy-based resin.

3. The rotor of the rotating electric machine according to claim 1, wherein the powdered resin has a powder particle size of 70 to 500 μm.

4. The rotor of the rotating electric machine according to claim 1, wherein a glass-transition temperature of the powdered resin is 110 to 160 degrees.

5. The rotor of the rotating electric machine according to claim 1, wherein an adhesive is mixed into the powdered resin.

6. The rotor of the rotating electric machine according to claim 1, wherein the powdered resin is colored.

7. The rotor of the rotating electric machine according to claim 1, wherein the permanent magnet is secured by the powdered resin.

8. A rotating electric machine comprising:
the rotor of the rotating electric machine according to claim 1; and
a stator facing the rotor via a void.

9. A method of manufacturing a rotor of a rotating electric machine, the rotor including a permanent magnet and a rotor core having a magnet insertion hole, the permanent magnet being inserted into the magnet insertion hole, the method comprising:
a first step of inserting the permanent magnet and a thermosetting powdered resin into the magnet insertion hole;
a second step of thermally hardening the powdered resin while rotating the rotor core; and
a third step of magnetizing the permanent magnet.

10. The method of manufacturing the rotor of the rotating electric machine according to claim 9, wherein, in the first step, the permanent magnet is inserted into the magnet insertion hole after the powdered resin is inserted into the magnet insertion hole.

11. The method of manufacturing the rotor of the rotating electric machine according to claim 9, wherein, in the first step, the powdered resin is inserted into the magnet insertion hole after the permanent magnet is inserted into the magnet insertion hole.

12. The method of manufacturing the rotor of the rotating electric machine according to claim 9, wherein the powdered resin in the first step is formed into a block in advance.

13. The method of manufacturing the rotor of the rotating electric machine according to claim 9, wherein, in the first step, the permanent magnet having a surface coated with the powdered resin is inserted into the magnet insertion hole.

14. The method of manufacturing the rotor of the rotating electric machine according to claim 10, wherein, in the first step, a surface of the magnet insertion hole is coated with the powdered resin.
